(19) United States
(12) Patent Application Publication
(10) Pub. No.: US 2016/0323313 A1
(43) Pub. Date: Nov. 3, 2016

(54) MOVING-TARGET DEFENSE WITH CONFIGURATION-SPACE RANDOMIZATION

(71) Applicant: TT GOVERNMENT SOLUTIONS, INC., Basking Ridge, NJ (US)

(72) Inventors: Sanjai NARAIN, Madison, NJ (US); Dana CHEE, Maplewood, NJ (US)

(73) Assignee: TT GOVERNMENT SOLUTIONS, INC., Basking Ridge, NJ (US)

(21) Appl. No.: 14/291,974

(22) Filed: May 30, 2014

Related U.S. Application Data
(60) Provisional application No. 61/829,309, filed on May 31, 2013.

(51) Int. Cl. H04L 29/06

(52) U.S. Cl. CPC H04L 63/1475; H04L 63/18; H04L 63/029

(57) ABSTRACT

There is set forth herein in on embodiment a method wherein configurations are changed. In one embodiment, configurations are changed in such a way that end-to-end requirements continue to be satisfied, the change is at minimum cost, and that at least one variable from a critical set of variables is changed.

### CROSS REFERENCE TO RELATED APPLICATIONS

This application claims priority to U.S. Provisional Application No. 61/829,309 filed May 31, 2013 entitled “Moving-Target Defense With Configuration-Space Randomization.” The above application is incorporated by reference.

### STATEMENT REGARDING FEDERALLY SPONSORED RESEARCH OR DEVELOPMENT

The disclosed invention was made with government support under contract No. FA8750-11-C-0012, awarded by the United States Department of Defense. The government has certain rights in the present invention.

### BACKGROUND

1. Field

Cyber security.

2. Discussion of the Background Art

The configuration of cyber infrastructure is its “DNA”. With even a partial knowledge of it, an adversary can obtain a deep understanding of its logical structure and hence of its structural vulnerabilities Such an understanding can allow the adversary to plan devastating attacks. For example, one can not only identify targets to attack but high-value ones such as single points of failure. Thus, it is critical to prevent or delay the acquisition of configuration knowledge by the adversary.

The present disclosure also provides many additional advantages, which shall become apparent as described below.

### SUMMARY

Configuration-Space Randomization (CSR) proactively, at random times, and at minimum change-cost, changes values of critical configuration variables. The change is accomplished in such a way that end-to-end system requirements continue to be satisfied but the adversary is forced to distinguish between current and obsolete values of the critical configuration variables. He cannot simply sniff messages in communication channels, read off their values from the messages and assume that these are current.

With each attack, one can associate a set of configuration variables, whose values, if known by an adversary, would enable him to launch an attack. This set of variables is called “critical” for that attack, Given a set of attacks and associated critical variables, CSR computes the minimum set of variables whose values, if obscured, would prevent the planning of all attacks.

CSR is implemented by specifying end-to-end system requirements for both security and functionality as constraints on component configurations, and then moving the cyber infrastructure through different solutions to those constraints. By definition, each solution satisfies the requirements. Each new solution must incur a minimum change cost from the current one, CSR accomplishes minimum-cost change by the use of a MaxSAT constraint solver.

Further objects, features and advantages of the present disclosure will be understood by reference to the following drawings and detailed description.

### BRIEF DESCRIPTION OF THE DRAWINGS

FIG. 1 is a diagram showing an overview of an Assured and Dynamic (ADC) system;

FIG. 2 is a diagram showing an ADC system architecture;

FIG. 3 is a diagram showing the design of a fault-tolerant virtual private network using office-automation;

FIG. 4 is a console showing active interface addresses;

FIG. 5 is a console showing a successful ping;

FIG. 6 is a data output showing successful capture of packets;

FIG. 7 is a data output showing trace routes;

FIG. 8 is a network diagram showing a network view observable by an adversary;

FIG. 9 is a network diagram showing a network view observable by an adversary after a first moving target defense (MTD) cycle:

FIG. 10 is a network diagram showing a network view observable by an adversary after a second MTD cycle.

### DETAILED DESCRIPTION OF THE PREFERRED EMBODIMENT

The present inventor has successfully evaluated the technique of the present disclosure for two different types of networks. The first is a fault-tolerant virtual private network. The second is a Multipoint Generic Routing Encapsulation (GRE) network. In both cases we change both physical and logical network identifiers. In the second case we also change the next-hop MGRE server identity.

CSR uniquely changes configurations in such a way that end-to-end security and functionality requirements continue to be satisfied, the change is at minimum cost, and that at least one variable from the critical set of each attack is changed. It is unique to the present disclosure to satisfy all of these design requirements simultaneously.

Prior solutions do not satisfy any of the above three design requirements that CSR does. They do not allow changing arbitrary configuration variables. They are restricted to changing definite ones such as IP addresses. Even for the variable that they do change, they provide no assurance that changes would continue to satisfy end-to-end security and functionality requirements. For example, when they change an IP address, they do not update firewall, tunneling and routing configurations to maintain end-to-end reachability and access-control requirements. They do not even consider minimum-cost change. Neither do they consider minimizing the set of configuration variables to change because this set is tightly restricted and hence very small.

Configuration is the “glue” for logically integrating components such as routers, switches, firewalls, servers and end-hosts to satisfy end-to-end infrastructure requirements. Configuration can be regarded as the “DNA” of infrastructure in that its analysis can provide a deep understanding of its structure, behavior and vulnerabilities. Due to the large gap between end-to-end requirements and detailed configurations satisfying these, a large number of configuration errors are made. It is well-documented that such errors are responsible for 50%-80% of cyber attacks and downtime in cyber infrastructure. Furthermore, knowledge of configuration can allow an adversary to map out the infrastructure and plan devastating attacks. He can identify not just targets but high-value targets such as single points of failure or those controlling physical systems. For example, such mapping and planning was used by the Stuxnet worm to severely damage Iran's nuclear facilities.

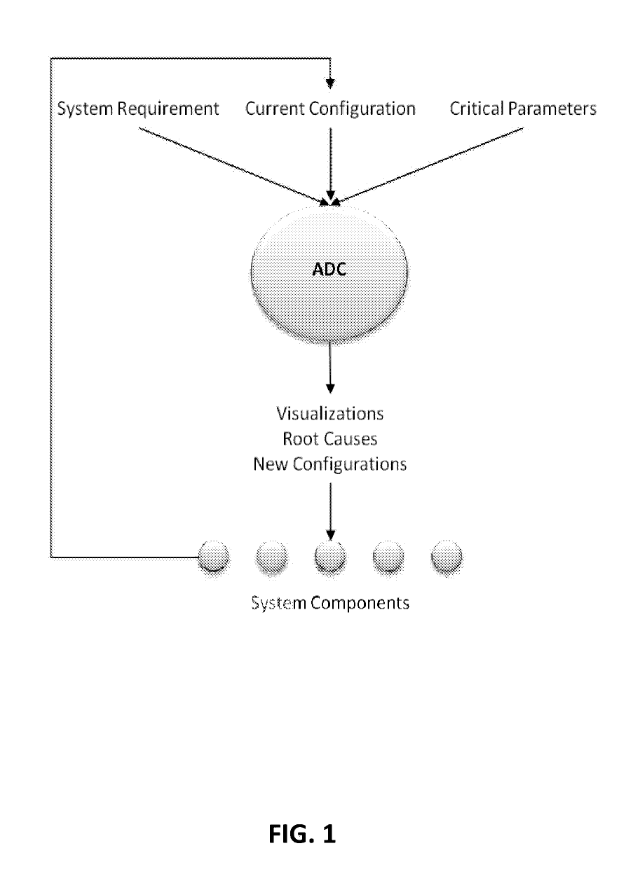

Thus, it is critical to develop systems that (a) eliminate configuration errors and (b) prevent, or drastically reduce the ability of an adversary to gain knowledge of the configuration. To achieve both these objectives. Applied Communication Sciences (ACS) has built a prototype called Assured and Dynamic Configuration or ADC, shown in FIG. 1. FIG. 1 shows an ADC system overview.

To achieve its first objective, ADC first provides a conceptual understanding of the infrastructure by displaying visualizations of logical structures and relationships latent in the Current Configuration. These also highlight various types of structural vulnerabilities. Then, ADC allows specification of a System Requirement on security and functionality in a new high-level language. Finally, ADC changes configurations to bring them into compliance with the requirements. If unable to do so, it outputs a concise root cause.

To achieve its second objective, ADC first allows specification of critical configuration parameters or variables. A parameter is critical if its knowledge would allow an adversary to plan an effective attack. Then, ADC periodically changes values of these parameters and propagates changes to other parameters throughout the system in such a way that System Requirement continues to be satisfied. This technique is called configuration-space randomization.

ADC leverages the ConfigAssure technology. ConfigAssure contains fundamental tools for eliminating configuration errors. ConfigAssure provides tools for visualization, specification, synthesis, debugging, verification and reconfiguration planning. ConfigAssure exploits the power of modern SAT-based constraint solvers that can solve millions of constraint in millions of Boolean variables in seconds.

ADC System Overview

As shown in FIG. 1, ADC will accept three inputs:
1. A System Requirement on global connectivity, security, performance and reliability
2. The Current Configuration representing current values of all configuration parameters
3. A set of Critical Parameters derived from knowledge about expected attacks.

ADC will then eliminate configuration errors and randomly change values of Critical Parameters, and of any other dependent ones, so that System Requirement holds and the number of changes is minimized. These configurations are then applied to the System Components.

To initially eliminate configuration errors, Critical Parameters is set to be the empty set. Then, ADC will change parameters in Current Configuration to their correct values to enforce System Requirement. Once the system is in a correct configuration, Critical Parameters is set to a non-empty set. For each class of attack, we assume that a set of Critical Parameters can be chosen so that randomly changing their values will (a) significantly invalidate the adversary's attempt at mapping and understanding the network and (b) blunt the force of his attack. If ADC establishes that System Requirement itself is unsolvable, it outputs a concise root-cause. ADC also presents a large number of visualizations of the logical structure latent in the configurations. These promote system understanding and highlight any structural vulnerabilities.

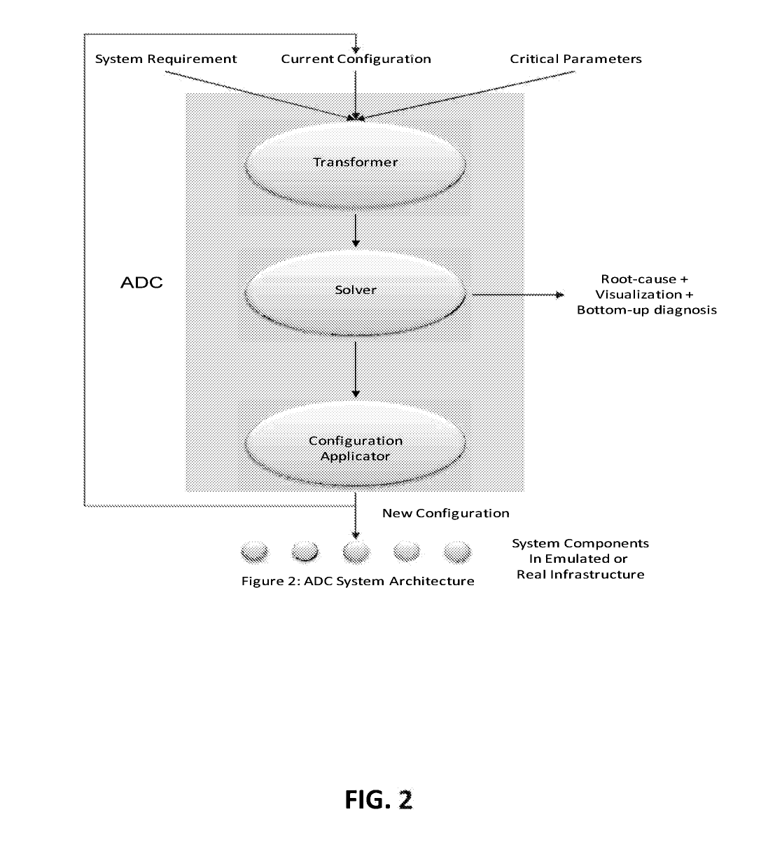

We now describe the architecture of ADC. Reference is made to FIG. 2 showing an ADC system architecture. As shown in FIG. 2, the three ADC inputs are fed into a Requirement Transformer. This transforms these into the conjunction of different types of constraints on configuration parameters. These constraints are input into a Requirement Solver. This finds a configuration satisfying the constraints. If it fails to do so, it outputs a root-cause of failure.

The new configuration is input to a Configuration Applicator. This first transforms configurations into vendor-specific formats, and then applies these to components. An out-of-band network is assumed over which the new configurations are transmitted to the components via a reliable protocol such as FTP. ADC can also check whether these configurations would be accepted by components. ADC is now described in more detail.

### 1. System Requirement

The System Requirement specifies the overall connectivity, security, performance and fault-tolerance architecture. ADC formalizes the intuition that a system architecture is a superposition of logical structures and relationships associated with different protocols. ADC provides a Requirement Library of such structures and relationships. Superposition is formalized by composition with Boolean operators, mainly AND but also NOT, OR, IMPLIES and XOR.

Conventional configuration languages force the administrator to pin down the exact value of each configuration parameter satisfying System Requirement. In general, System Requirement may be a complex one consisting of many subsidiary requirements. A value that is correct for implementing one requirement may be incorrect for another. It is hard to pick the exact values that will satisfy all requirements. An administrator spends an enormous amount of time choosing values and then backtracking if choices made to satisfy a requirement conflict with those made to satisfy an earlier one.

ADC eliminates such backtracking. It allows the administrator to specify requirements as constraints on configuration variables. A constraint is equivalent to a set of values. ADC then uses a constraint solver to compute the intersection of all these sets. This intersection then satisfies all requirements.

An ADC requirement is a constraint. A constraint is simply a relationship between configuration parameters. Conventional configuration languages force the administrator to pin down the exact value of each configuration parameter. A value that is correct for implementing one requirement may be incorrect for another. It is hard to pick the exact values that will satisfy a typically large number of requirements. By contrast, a constraint allows the administrator to specify a set of acceptable values. Thus, the chances of finding a non-empty intersection of these sets are much higher. This intersection is exactly what modern constraint solvers efficiently compute. For example, Princeton's ZChaff solver can solve millions of Boolean constraints in millions of Boolean variables in seconds. Constraint solvers generalize the advantage of spreadsheets. In the latter, constraints are only arithmetic and one way. With the former, constraints can be symbolic and multi-way in that there is no notion of dependent and independent variables.

However, Boolean logic is too low level to be useful as a specification language for configuration. For example, for networking, one would like variables whose values are not Boolean but host names, interfaces, addresses. One would like constraints between these to capture logical structures such as subnets. IP Security (IPSec)/Multiprotocol Label Switching (MPLS) tunnels and static routes.

A good constraint language for configuration is called Equality with Uninterpreted Functions (EUF). It can be regarded as Boolean logic with data structures. EUF constraints can be efficiently solved by Satisfiability Modulo Theories (SMT) solvers such as Yices. In fact, for this language, they are faster than even SAT solvers.

A very important feature of EUF is that variables names can be complex terms, not just structure-free atomic ones. This means that the administrator will not have to find a distinct atomic name for each variable. There can be thousands of configuration variables in a large system. Finding distinct names for these and relating these across multiple components is hard, EUF allows one to define a small number of semantically meaningful function symbols and combine them in a large number of ways. Each combination is a semantically meaningful variable. For example, instead of inventing new variables for the IP address of each interface, we define a function symbol “ip address” of two arguments, a host and an interface. Now, for any host H and interface I, the term “ip address H I” represents the IP address of I at H. Internally, this term is implemented as the expression ip_address(H, I).

### 2. Current Configuration

The current configuration is the set of configuration files of all system components. These are parsed into a large constraint CDB of the form xl=clz,25 . . . z,25 xk=ck where each xi is a variable occurring in the System Requirement and ci is its value. The value is extracted from analyzing component configuration files. Currently, ADC only analyzes Cisco IOS configuration files. The analysis is done in two stages. First, the files are parsed into a Prolog database. Then, the values of variables are extracted from this database.

### 3. Critical Parameters

These are specified as a list of configuration variables. For each class of attack, we assume that a set of Critical Parameters can be chosen so that randomly changing their values will significantly invalidate the adversary's attempt at mapping and understanding the network or blunt the force of his attack. The choice of critical variables depends on what configuration information we'd like the adversary not to acquire, or what configuration information is likely to assist the adversary plan an effective attack. For example:
To make it harder for an adversary to identify single points of path failure, we could change configurations relating to topology such as network identifiers for physical and logical links. We could also change routing protocol configurations since such protocol messages contain pieces of topology information.
To make it harder for an adversary to identify single points of component failure, we might change the HSRP-relatcd addresses of an unreplicated component so that an adversary would sniff HSRP messages from multiple addresses and believe that the component is replicated.
To make it harder to be detected by a scanning adversary, we could change the IP addresses of hosts. This defense is called Random Host Mutation
To make it harder for an adversary to reconstruct application layer flow information, we could send parts of that flow along multiple independent paths. This is called Random Route Mutation.

### 4. Requirement Transformer

The Requirement Transformer accomplishes the following tasks:
1. Transform the Current Configuration into a conjunction CDB of constraints of the form x=c where x is a configuration variable in the System Requirement and c is its value in the Current Configuration.
2. Transform the System Requirement into a NormalForm that can be submitted to an SMT solver
3. Create MTDConstraint for changing some variables in Critical Parameters.

We now sketch how these tasks are accomplished.

4.1 Transforming Current Configuralion into a Conjunction CDB of Constraints of the Form x=c

Section 2, above outlines how to accomplish this task.

4.2 Computing NormalForm

This task is accomplished by the Prolog predicate eval(P, Q) where P is a system requirement and Q is a constraint that can be submitted to an SMT solver. This constraint is a Boolean combination of primitive constraints mainly of the form T1=T2 where T1 and T2 are terms representing configuration variables or constants. Other primitive constraints are on bitvector and arithmetic operations. If P is a constraint in the Requirement Library, then ADC rewrites it into a simpler constraint R, and recursively calls eval on R. The rewrite rules are defined by the infix, binary predicate=>whose first argument is a constraint and the second argument is its simplified version. If P is a Boolean combination of constraints then eval is recursively called on the constituents, and the results combined. If no=>rules apply, then eval returns the constraint itself.

An example of a=>rule for IPSec is:

ipsec_tunnel(H1, I1, H2, I2, ID1, ID2)=>

and_each([ipsec_ea(H1, I1, H2, I2)=ipsec_ea(H2, I2, H1, I1),

ipsec_ha(H1, I1, H2, I2)=ipsec_ha(H2, I2, H1, I1),

ipsec_key(H1, I1, H2, I2)=ipsec_key(H2, I2, H1, I1),

ipsec_remote(H1, I1, H2, I2)=ip_address(H2, I2),

ipsec_remote(H2, 12, H1, I1)=ip_address(H1, I1),

ipsec_local(H1, I1, H2, I2)=ip_address(H1, I1),

ipsec_local(H2, I2, H1, I1)=ip_address(H2, I2),

ipsec_acl_id(H1, I1, H2, I2)=ID1,

ipsec_acl_id(H2, I2, H1, I1)=ID2]).

This encodes the requirement that in order for there to be an IPSec tunnel between interface I1 of host H1 and interface I2 of host H2, the IPSec keys and encryption and hash algorithms must be identical, and the peer addresses should be symmetric. Furthermore, the access-control list identifiers at each end must be as specified, and_each returns a conjunction of all constraints in its argument.

4.3 Computing MTDConstraint

To create MTDConstraint, ADC randomly selects a configuration variable x in Critical Parameters, find its value c in Current Configuration and then lets MTDConstraint be not(x=c). This forces a new value of x to be found, if possible. If a new value cannot be found, for example, if x=c were part of System Requirement, then no solution is produced and the current configuration is unchanged. When ADC recomputes a solution, a new critical variable could be selected.

### 5. Requirement Solver

The Requirement Transformer sends the conjunction FinalReq=CDB [symbol] NormalFormz,25 MTDConstraint to the Requirement Solver for solution. The Requirement Solver further transforms FinalReq and all type declarations into the concrete syntax of an SMT solver, calls that solver, and parses the result back into Prolog. Currently, the Yices SMT solver is used.

If the solution does not exist then the constraint solver returns an “unsat-core”. This is a typically small conjunction of unsolvable constraints whose solvability is a necessary condition for that of FinalReq. If in this set there is an equation x=c where x=c is also in CDB, then this equation signifies a configuration error. Repair then means finding a new value of x. This is accomplished by deleting x=c from CDB and reattempting a solution to FinalReq. Effectively, we let x “float”. This repair step is repeated till either a solution is found or no more deletions are possible. If the latter, then NormalFormz,25 MTDConstraint is unsolvable and the resulting unsat-core is reported to the user. Note that since CDB is finite, the repair algorithm will terminate.

Effectively, the above plan repairs implementation errors: CDB does not implement NormalFormz,25 MTDConstraint so it needs to be changed so that it does. The above plan could also be used to repair NormalFormz,25 MTDConstraint itself. But, the unsolvability of that constraint represents a design error that requires human intervention before it is changed.

### 6. Configuration Applicator

This nmodule translates a solution produced by the Requirement Solver into vendor-specific configuration files for all components. When these are applied to the components, their configuration variables are set to values in the solution. A solution is of the form xl=cl . . . , x=ck where each xi is a variable and each ci is a constant. Intuitively, it keeps a list of IOS block types it needs to generate for each router. It goes through the solution and associates each equation with one or more blocks for a given router. Then, it processes the information in each block and generates the IOS block.

### 7. Optimal Critical Variable Selection and Changing Critical Variables at Minimum Cost

The critical set of an attack is defined as the set of variables whose values an adversary needs to know to launch that attack. In each moving-target defense cycle. ADC needs to change at least one variable in each set to defend against all attacks. ADC must now solve two problems. The first is finding the minimum set of variables whose values, if changed, would defend against all attacks. This is not, in general, the union of all the critical sets. For example, let there be three attacks, A(1), A(2) and A(3) with the following critical sets: X^{A}(1)={x₁, x₂}, X^{A}(2)={x₂, x₃}, X^{A}(3)={x₃, x₄}. Even though there are four critical variables in all, it is only necessary to change just two. In fact, three solutions are possible: {x₁, x₃}, {x₂, x₃}, {x₂, x₄}.

The second problem ADC must solve is ensuring that values of variables in the minimum set must be changeable from their current values. In other words, the constraint that their values be different from their current ones should not be inconsistent with System Requirement.

We now sketch how both these problems can be addressed with a MaxSAT constraint solver. We model finding a minimal set with minimizing variable value change cost. MaxSAT allows one to associate weights with a set of constraints. It then finds a solvable subset of this set with maximum weight. The weight of a set of constraints is the sum of weights of all constraints in that set.

ADC would now construct the MTDConstraint of Section [0044] as follows: For every attack A, where the critical set of A is {x1, . . . , xk)}, generate the disjunction [symbol] xₗ=cₗ [symbol] . . . [symbol] xₖ=cₖ where cᵢ is the current value of xᵢ, in the configuration database CDB, and return a conjunction of these. ADC would also generate a constraint called ChangeCost that declares the cost of changing a variable's value from its current one. Finally, ADC would submit FinalReq where:

FinalReq=CDBz,25 NormalFormz,25 MTDConstraintz,25 ChangeCost

to a MaxSAT constraint solver. Recall that NormalForm is a normalized version of System Requirement. Obviously, FinalReq is inconsistent because MTDConstraint forces all variable values to be different from those in CDB. MaxSAT will then drop some constraints in CDB so that the change cost is a minimum. Thereby, at least one variable in each attack's critical set will be changed but at minimum cost and be consistent with System Requirement.

### 8. Illustrating ADC and Configuration-Space Randomization

8.1 Designing Requirements for a Fault-Tolerant Virtual Private Network

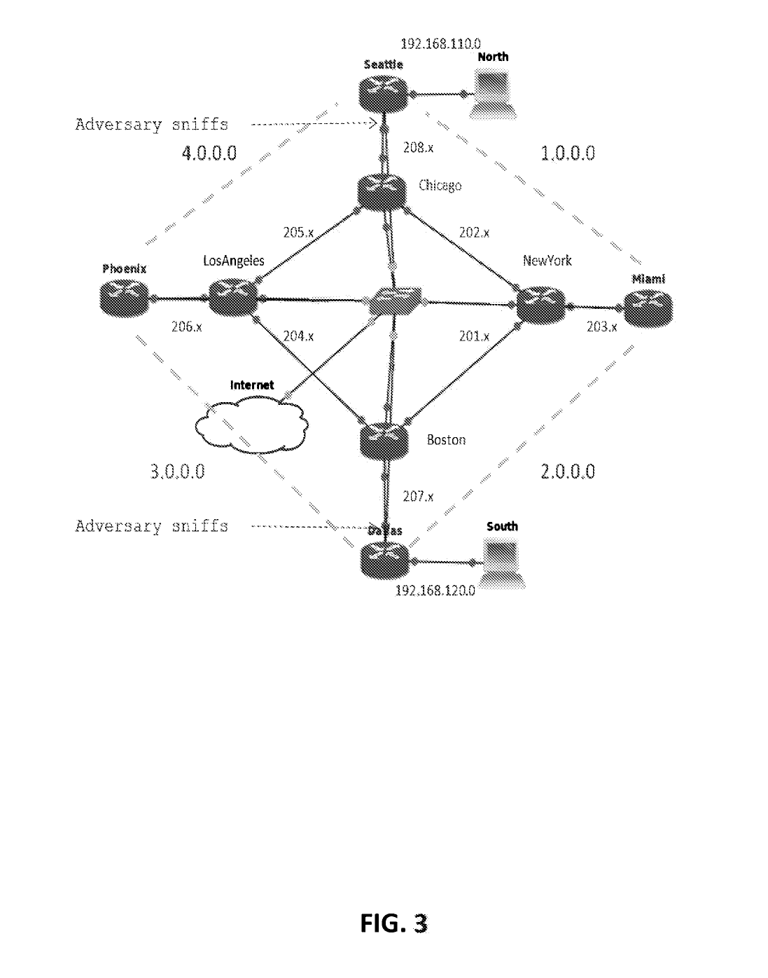

FIG. 3 shows the design of a fault-tolerant virtual private network (“VPN”) for setting up a private community of interest over a public backbone. This design is commonly used in the government and industry. There are four sites that need to privately share information. These sites route their traffic out of their gateway routers, respectively, Seattle, Miami, Dallas and Phoenix. Privacy is ensured by setting up a ring of IPSec tunnels between these routers. Thus, video from server North is forwarded to Seattle and routed to Dallas along either side of the ring. Dallas decrypts the video and forwards it on to the client South.

Reference is made to FIG. 3 showing the design of a fault-tolerant virtual private network using office-automation.

Automatic rerouting over this ring can be accomplished by running a routing protocol such as Open Shortest Path First (OSPF) over the four gateway routers. However, OSPF does not recognize IPSec links. For OSPF to do so, both link end points need to be on the same subnet. In general, the end points of an IPSec tunnel are in different subnets. To create the illusion that these end points are directly connected, we need to use a new type of tunnel called GRE. Thus, a GRE tunnel is set up under every IPSec tunnel and OSPF is made to run over the GRE network. Now, for example, if Miami should fail, video would be automatically rerouted via Phoenix to Dallas.

The above VPN is supported by a wide-area network (WAN), also set up as a ring over which the RIP routing protocol is run. Each gateway router is connected to its own wide-area network router.

All WAN and VPN routers are controlled over an out-of-band network. Control interfaces of all routers are connected to a switch in the middle.

The above design is refined into more concrete requirements. These can be handed to a network administrator for implementation. The requirements are:

### Video Client and Server Types, Connections and Default Routing

North and South are both Linux machines
North is connected to Seattle
South is connected to Dallas
North forwards all traffic to Seattle/FastEthernet0/1 whose address is 192.168.110.1
South forwards all packets to Dallas/FastEthernet0/1 whose address is 192.168.120.1

### VPN Connectivity

There is a ring of IPSec tunnels between gateway routers Seattle, Miami, Dallas and Phoenix
Every IPSec tunnel is supported by a GRE tunnel numbered 1.0.0.0/24 through 4.0.0.0/24.

### Routing in VPN

OSPF is run over the GRE tunnels

### Backbone Network

The backbone network is a ring of core routers Los Angeles, Boston, Chicago, New York
Every gateway router is connected to a core router
The eight physical links are numbered 201.1.1.0/24 through 208.1.1.0/24.

### Routing in Backbone Network

RIP is run over the backbone network

### Control Network

Every router is connected to the 192.168.80.0/24 back channel network

### Routing Video Over VPN

All video traffic between client and server is routed over the VPN. This is accomplished by including the client and server subnets into the OSPF routing domain.

8.1.1 Specifying Requirements in ADC

These requirements are specified in ADC's language as in Table 1 in about 66 lines.

```
TABLE 1
ADC specification of fault-tolerant VPN
Video client and server types, connections and default routing
component type North = linux
component type South = linux
subnet 192.168.110.0 24 North eth0 Seattle FastEthernet0/1
subnet 192.168.120.0 24 South eth0 Dallas FastEthernet0/1
next hop North 0.0.0.0 32 = ip address Seattle FastEthernet0/1
next hop South 0.0.0.0 32 = ip address Dallas FastEthernet0/1
ip address Seattle FastEthernet0/1 192.168.110.1 24
ip address Dallas FastEthernet0/1 192.168.120.1 24
VPN connectivity
gre ipsec tunnel 1.0.0.0 24
        Seattle Tunnel0 FastEthernet0/0
        Miami Tunnel0 FastEthernet0/0
gre ipsec tunnel 2.0.0.0 24
        Miami Tunnel1 FastEthernet0/0
        Dallas Tunnel0 FastEthernet0/0
gre ipsec tunnel 3.0.0.0 24
        Dallas Tunnel1 FastEthernet0/0
        Phoenix Tunnel0 FastEthernet0/0
gre ipsec tunnel 4.0.0.0 24
    Phoenix Tunnel1 FastEthernet0/0
        Seattle Tunnel1 FastEthernet0/0
Routing in VPN
ospf domain 0 1 5
  Seattle Tunnel0 Miami Tunnel0
  Miami Tunnel1 Dallas Tunnel0
  Dallas Tunnel1 Phoenix Tunnel0
  Phoenix Tunnel1 Seattle Tunnel1
Backbone network
subnet 201.1.1.0 30 NewYork FastEthernet0/0 Boston FastEthernet0/0
subnet 202.1.1.0 30 NewYork FastEthernet0/1 Chicago FastEthernet0/0
subnet 203.1.1.0 30 NewYork FastEthernet1/1 Miami FastEthernet0/0
subnet 204.1.1.0 30 LosAngeles FastEthernet0/0 Boston FastEthernet0/1
subnet 205.1.1.0 30 LosAngeles FastEthernet0/1 Chicago FastEthernet0/1
subnet 206.1.1.0 30 LosAngeles FastEthernet1/1 Phoenix FastEthernet0/0
subnet 207.1.1.0 30 Boston FastEthernet1/1 Dallas FastEthernet0/0
subnet 208.1.1.0 30 Chicago FastEthernet1/1 Seattle FastEthernet0/0
Routing in backbone network
rip domain
  NewYork FastEthernet0/0 Boston FastEthernet0/0
  NewYork FastEthernet0/1 Chicago FastEthernet0/0
  LosAngeles FastEthernet0/1 Chicago FastEthernet0/1
  LosAngeles FastEthernet0/0 Boston FastEthernet0/1
  NewYork FastEthernet1/1 Miami FastEthernet0/0
  LosAngeles FastEthernet1/1 Phoenix FastEthernet0/0
  Chicago FastEthernet1/1 Seattle FastEthernet0/0
  Boston FastEthernet1/1 Dallas FastEthernet0/0
Routing video over VPN
redistribute Seattle ospf connected = true
redistribute Dallas ospf connected = true
Control network
ip address Boston FastEthernet1/0 192.168.80.21 24
ip address Chicago FastEthernet1/0 192.168.80.22 24
ip address Dallas FastEthernet1/0 192.168.80.23 24
ip address LosAngeles FastEthernet1/0 192.168.80.24 24
ip address Miami FastEthernet1/0 192.168.80.25 24
ip address NewYork FastEthernet1/0 192.168.80.26 24
ip address Phoenix FastEthernet1/0 192.168.80.27 24
ip address Seattle FastEthernet1/0 192.168.80.28 24
```

When this specification is uploaded to ADC, ADC generated two Linux scripts and eight Cisco IOS files totaling 450 lines. The script for North and configuration file for Seattle are listed in Table 2 below.

TABLE 2
Configuration script for North and configuration file for Seattle
Script for North

ifconfig eth0 192.168.110.5 netmask 255.255.255.0 up
ip route add 0.0.0.0/32 via 192.168.110.1

Configuration file for Seattle

hostname Seattle
no ip domain-lookup
snmp-server community public rw
interface FastEthernet0/0
no shutdown
ip address 208.1.1.1 255.255.255.252
interface FastEthernet0/1
no shutdown
ip address 192.168.110.1 255.255.255.0
interface FastEthernet1/0
no shutdown
ip address 192.168.80.28 255.255.255.0
interface Tunnel0
no shutdown
ip address 1.0.0.5 255.255.255.0
ip ospf dead-interval 5
ip ospf hello-interval 1
tunnel source 208.1.1.1
tunnel destination 203.1.1.1
interface Tunnel1
no shutdown
ip address 4.0.0.2 255.255.255.0
ip ospf dead-interval 5
ip ospf hello-interval 1
tunnel source 208.1.1.1
tunnel destination 206.1.1.1
router ospf 9999
redistribute connected
network 1.0.0.5 0.0.0.0 area 0
network 4.0.0.2 0.0.0.0 area 0
router rip
version 2
network 208.1.1.1

8.1.2 Testing Configurations

The generated configurations were applied to emulated routers in a GNS3 tested and a number of tests performed to evaluate whether intended requirements were satisfied.

8.1.2.1 Testing Connectivity

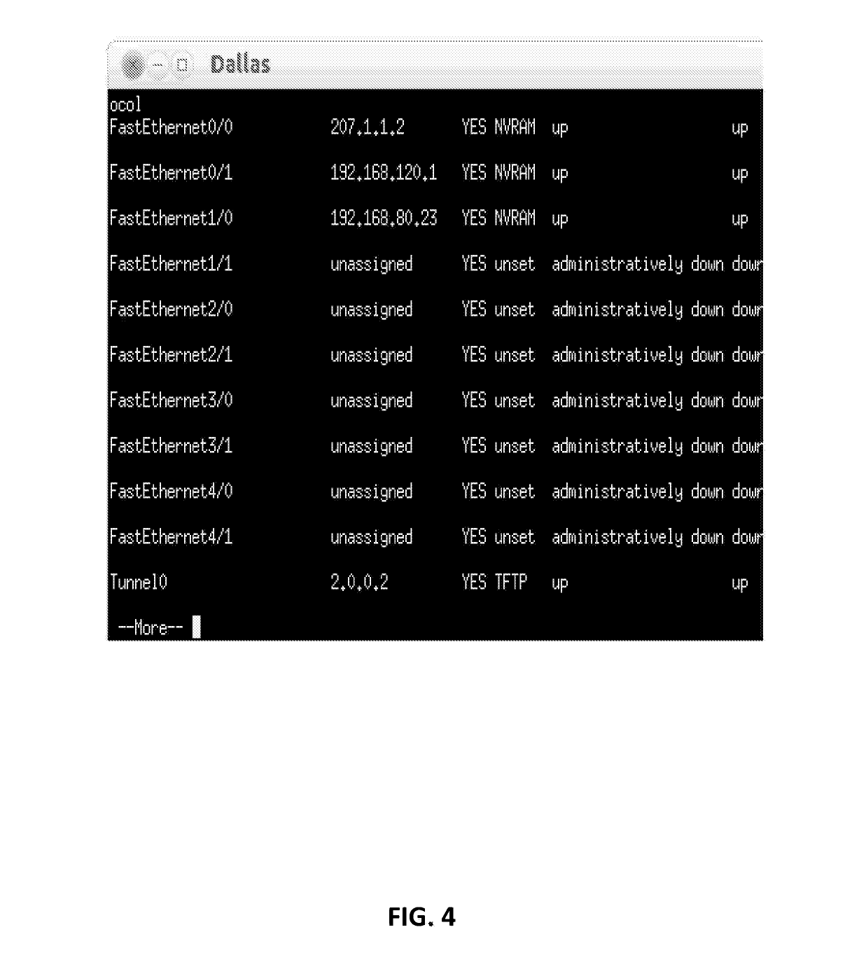

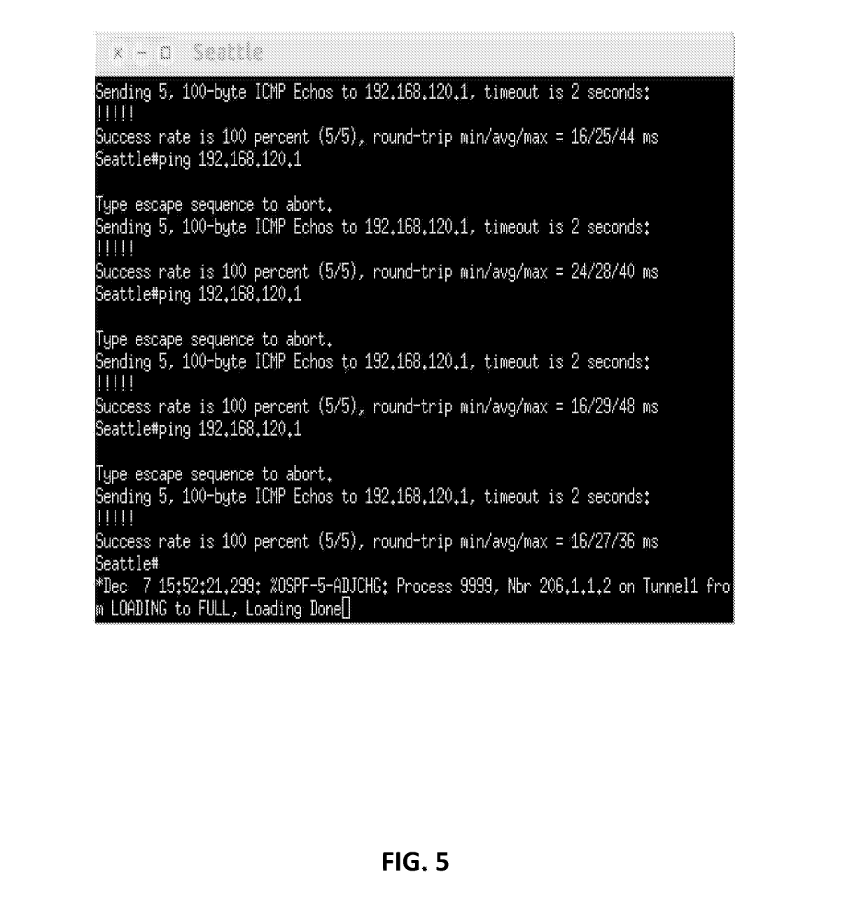

Using GNS3, consoles to the Dallas and Seattle routers were opened as shown in FIGS. 4 and 5. FIG. 4 shows that Dallas has an interface 192.168.120.1. FIG. 5 shows that this was successfully pinged from Seattle. This test showed that connectivity was established between the two routers. Referring to FIG. 4, FIG. 4 is a console for Dallas showing active interface addresses. Referring to FIG. 5. FIG. 5 is a console for Seattle showing a successful ping to Dallas.

8.1.2.2 Testing Encryption

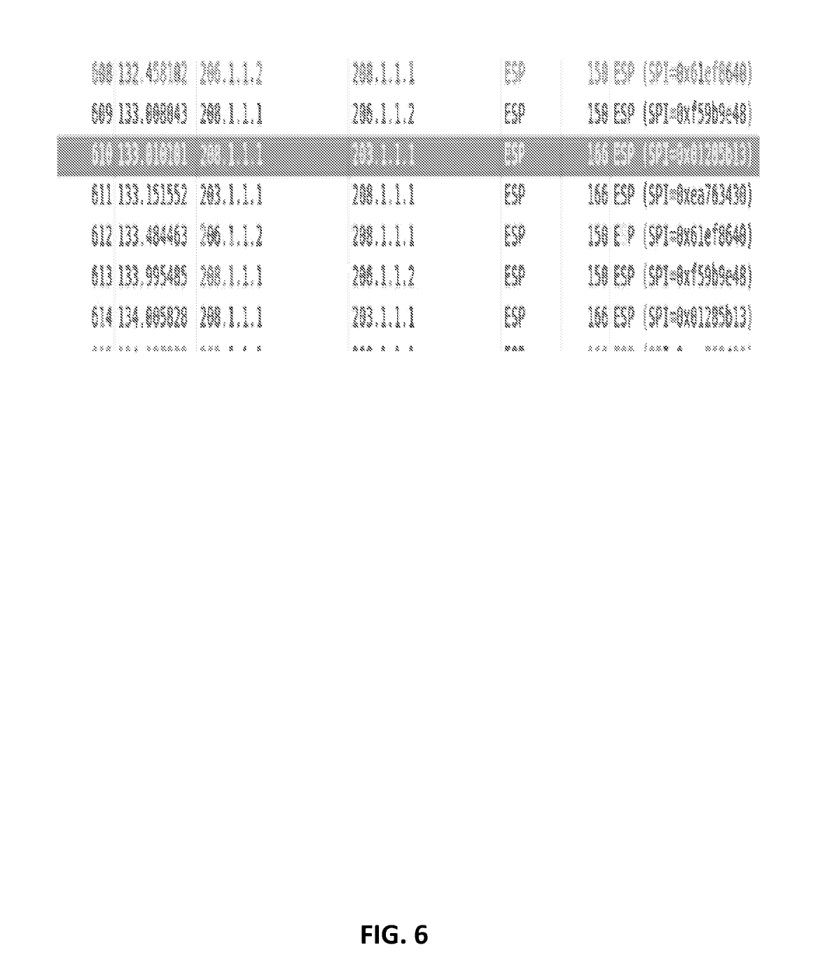

To test whether the pings are encrypted, we use GNS3's embedded Wireshark capability to capture packets flowing in and out of Seattle. As shown in FIG. 6, we notice that these are all ESP packets, signifying that they are encrypted. Referring to FIG. 6, FIG. 6 is a data output showing a Wireshark capture of packets in and out of Seattle.

8.1.2.3 Testing Fault-Tolerance

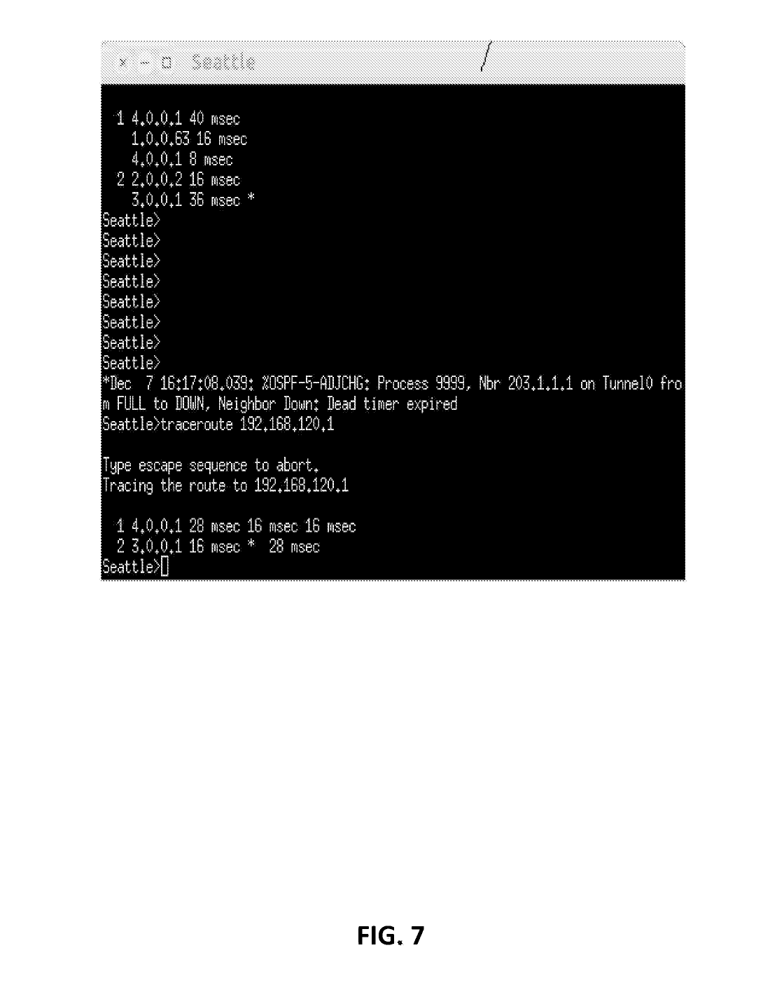

To test that fault-tolerance has been correctly implemented, we first do a trace route to 192.168.120.1 and notice that there are two routes that packets take to travel from Seattle to Dallas. One is via Miami and the other via Phoenix. We then suspend Miami via the GNS3 GUI. Another trace route reveals just one path to Dallas, via Phoenix. Referring to FIG. 7, FIG. 7 is a data output showing trace routes. FIG. 7 shows two routes to Dallas but after suspension of Miami, shows just a single route.

### 9. Experimental Evaluation of ADC to Implement a Moving-Target Defense

This section describes the experiment we ran to assess the use of ADC to defend the fault-tolerant VPN network of Section 8 against an attack where an adversary infers network topology from sniffing routing protocol updates. An adversary could use this information to identify a single point of failure and concentrate his DoS resources on bringing it down. Our moving-target defense periodically changes the network identifiers of links (identified as critical parameters or variables in ADC) so that the adversary is forced to disambiguate between current and stale routing protocol updates. If he does not, then his view of the network becomes more and more distorted over time. However, as in the previous section, trace route shows that end-to-end connectivity continues to be maintained.

9.1 Specifying Moving-Target Defense

The critical variables and their possible values are:
The network ID of the GRE tunnel between Seattle and Miami: 1.0.0.0 or 10.0.0.0
The network ID of the GRE tunnel between Miami and Dallas: 2.0.0.0 or 20.0.0.0
The network ID of the physical link between New York and Boston. 201.1.1.0 or 201.10.1.0

These are encoded with the following lines in the specification:

Declare Critical Variables

critical variables
network id Seattle Tunnel0
network id Miami Tunnel1
network id NewYork FastEthernet0/0

Specify their choices

or network id Seattle Tunnel0=1.0.0.0
network id Seattle Tunnel0=10,0.0.0

or network id Miami Tunnel1=2.0.0.0
network id Miami Tunnel1=20.0.0.0

or network id NewYork FastEthernet0/0=201.1.1.0
network id NewYork FastEthernet0/0=201.10.1.0

Replace network addresses with variables in GRE tunnels and subnet

specifications. ADC will replace these with values and then generate

actual addresses.

gre tunnel
network id Seattle Tunnel0 24
Seattle Tunnel0 FastEthernet0/0
Miami Tunnel0 FastEthernet0/0

gre tunnel
network id Miami Tunnel1 24
Miami Tunnel1 FastEthernet0/0
Dallas Tunnel0 FastEthernet0/0

subnet
network id NewYork FastEthernet0/0 30
NewYork FastEthernet0/0
Boston FastEthernet0/0

9.2 Emulating Adversary Behavior

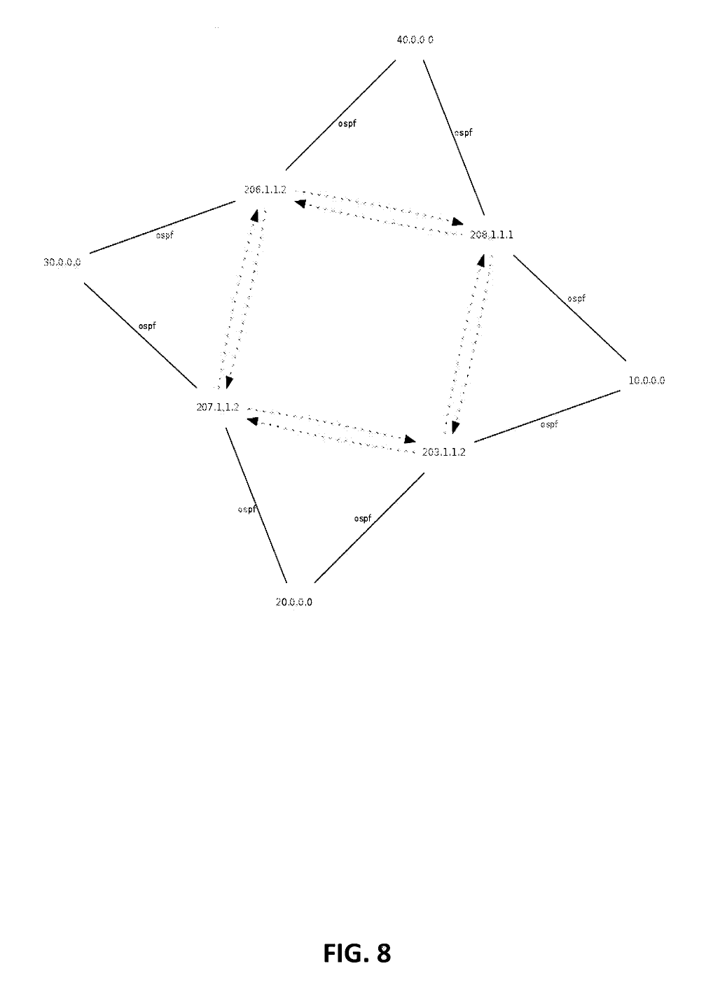

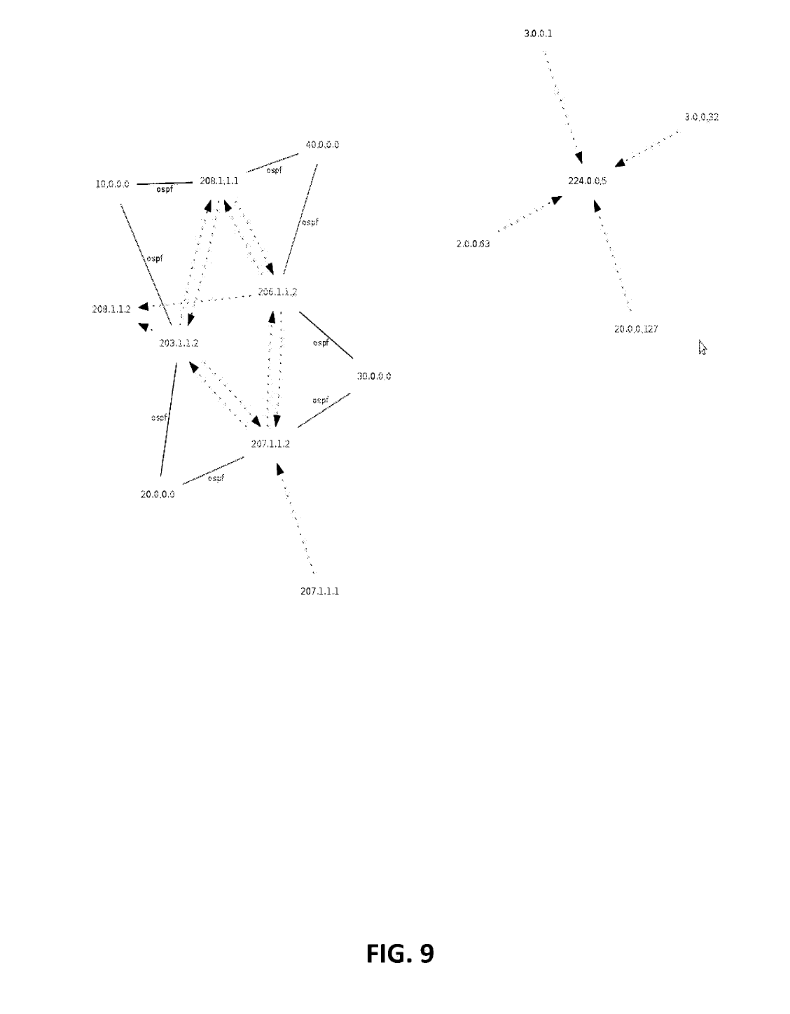

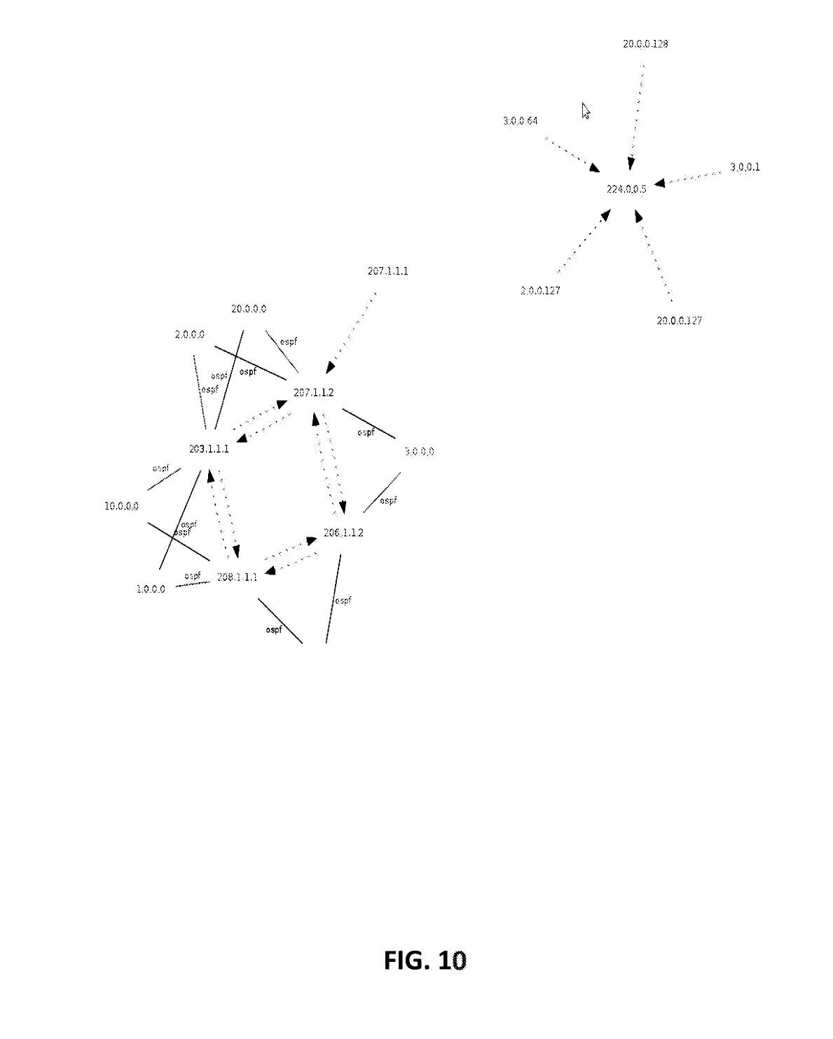

We used GNS3's embedded Wireshark tool to sniff OSPF packets on selected links and plot the topology latent in these packets. Since OSPF packets convey link state information, the entire topology of the OSPF domain can be reconstructed from analysis of those packets. As shown in FIG. 8, initially, the adversary is able to reconstruct the correct view of the network. Referring to FIG. 8. FIG. 8 is a network diagram showing an IP security network between four gateway routers. It shows the GRE links numbered 10.0.0.0 through 40.0.0.0 and the physical routers that support them. But as the configurations are changed with ADC's moving-target defense, his view becomes progressively more distorted as shown in FIGS. 9 and 10. Referring to FIG. 9. FIG. 9 is a network diagram illustrating that an adversary's view becomes distorted after one moving target defense (MTD) cycle. Referring to FIG. 10, FIG. 10 is a network diagram illustrating that an adversary's view becomes more distorted after a second MTD cycle. The adversary begins to see two GRE tunnels between the routers 207.1.1.2 and 203.1.1.1 and between 203.1.1.1 and 2081.1.1.

1. A method of defending a cyber infrastructure, the cyber infrastructure comprising a first set of configuration variables and a second set of configuration variables, the first set of configuration variables being a set of critical configuration variables, the method comprising:
selecting a changed value for at least one critical configuration variable of the set of critical configuration variables; and
determining a configuration variable of the second set of configuration variables, the configuration variable of the second set of configuration variables being determined to maintain functionality of the cyber infrastructure.

2. The method of claim 1, wherein the configuration variable of the second set of configuration variables is determined to satisfy the changed value for the at least one critical configuration variable.

3. The method of claim 1, further comprising analyzing an attack to derive the set of critical configuration variables, the set of critical configuration variables being variables which if known by an adversary would allow the adversary to launch an attack against the cyber infrastructure.

4. The method of claim 1, wherein the selecting comprises randomly selecting the changed value for the at least one critical configuration variable of the set of critical configuration variables.

5. The method of claim 1, further comprising specifying functionality requirements of the cyber infrastructure as constraints on the first and second sets of configuration variables of the cyber infrastructure, wherein the determining includes evaluating different solutions of the constraints.

6. The method of claim 1, further comprising specifying functionality and security requirements of the cyber infrastructure as constraints on the configuration of the cyber infrastructure, wherein the determining includes evaluating different solutions of the constraints.

7. The method of claim 1, wherein the selecting includes finding a minimum set of critical configuration variables to defend against an attack.

8. The method of claim 1, wherein the selecting a changed value includes computing the changed value.

9. The method of claim 1, further comprising minimizing a cost of implementing changes to a configuration of the cyber infrastructure.

10. The method of claim 1, wherein the selecting and determining and are performed using a constraint solver so that a number of changes to the cyber infrastructure is minimized.

11. The method of claim 1, wherein the cyber infrastructure comprises multiple system components, and wherein the method further comprises applying component configuration variables to system components of the multiple system components.

12. The method of claim 11, wherein the cyber infrastructure is connected by an out-of-band network, and the applying comprises transmitting, via the out-of-band network, some of the first and second sets of configuration variables of the cyber infrastructure.

13. The method of claim 1, wherein the at least one critical configuration variable includes an IP address, and wherein the configuration variable of the second set of configuration variables is a configuration variable selected from the group consisting of a firewall configuration variable, a tunneling configuration variable, and a routing configuration variable.

14. A method of defending a cyber infrastructure, the cyber infrastructure comprising a first set of configuration variables and a second set of configuration variables, the method comprising:
selecting a changed value for at least one first configuration variable of the first set of configuration variables; and
determining a configuration variable of the second set of configuration variables, the configuration variable of the second set of configuration variables being determined to maintain functionality of the cyber infrastructure; and
minimizing a cost of performing the selecting a changed value for at least one first configuration variable of the first set of configuration variables, and of determining the configuration variable of the second set of configuration variables.

15. The method of claim 14, wherein the configuration variable of the second set of configuration variables is determined to satisfy the changed value for the first set of configuration variables.

16. The method of claim 14, further comprising specifying functionality requirements of the cyber infrastructure as constraints on the first and second configuration variables of the cyber infrastructure, wherein the determining includes evaluating different solutions of the constraints.

17. The method of claim 14, further comprising specifying functionality and security requirements of the cyber infrastructure as constraints on the configuration of the cyber infrastructure, wherein the determining includes evaluating different solutions of the constraints.

18. A method of defending a cyber infrastructure, the cyber infrastructure comprising a first set of configuration variables and a second set of configuration variables, the first set of configuration variables being a set of critical configuration variables, the set of critical configuration variables including a first critical configuration variable and a second critical configuration variable, the method comprising:
selecting a first changed value of the set of critical configuration variables;
determining a configuration variable of the second set of configuration variables, the determining including maintaining functionality of the cyber infrastructure and satisfying the first changed value;
selecting, after a period of time, a second changed value of the set of critical configuration variables; and
determining another configuration variable of the second set of configuration variables, the determining including maintaining functionality of the cyber infrastructure and satisfying the second changed value.

19. The method of claim 18, wherein the first changed value is of the first critical configuration variable, and wherein the second changed value is of the second critical configuration variable.

20. The method of claim 18, wherein the first changed value is of the first critical configuration variable, and wherein the second changed value is of the first critical configuration variable.

21. (canceled)

22. (canceled)

23. (canceled)

24. (canceled)

25. (canceled)
